(19) United States
(12) Patent Application Publication
(10) Pub. No.: US 2025/0173743 A1
(43) Pub. Date: May 29, 2025

(54) PROPOSAL SUPPORT SYSTEM, PROPOSAL SUPPORT METHOD, AND PROPOSAL SUPPORT PROGRAM

(71) Applicant: Hitachi, Ltd., Tokyo (JP)

(72) Inventors: Hiroaki NASU, Tokyo (JP); Yuko TSUCHIYA, Tokyo (JP); Koji UTSUMI, Tokyo (JP)

(21) Appl. No.: 18/917,048

(22) Filed: Oct. 16, 2024

(30) Foreign Application Priority Data
Nov. 27, 2023 (JP) 2023-199899

(51) Int. Cl. G06Q 30/0201; G06F 40/295

(52) U.S. Cl. CPC G06Q 30/0201; G06F 40/295

(57) ABSTRACT

A system acquires a specific first word from a network in which each first word of a first word group in a first sentence group including a first field name in a source out of a first source related to a first field and a second source related to a second field different from the first field is a node, and a relationship between two first words is a link connecting the nodes, extracts company names in the second field related to the specific first word, from a second sentence group including a second field name and the specific first word from the source, associates the specific first word, a specific second word, and the company names in the second field, based on information regarding the specific second word that co-occurs with the specific first word in a second word group in the second sentence group, and outputs a result.

### CLAIM OF PRIORITY

The present application claims priority from Japanese patent application No. 2023-199899 filed on Nov. 27, 2023, the content of which is hereby incorporated by reference into this application.

### BACKGROUND OF THE INVENTION

### 1. Field of the Invention

The present invention relates to a proposal support system, a proposal support method, and a proposal support program, which supports proposal.

### 2. Description of Related Art

JP2017-027486A discloses a promising customer prediction apparatus that classifies customers into groups that are meaningful from a sales strategy perspective and predicts promising customers. This promising customer prediction apparatus includes a customer information storage means that stores not only customer company information, which is publicly available company information, but also information including sales activity information obtained individually from sales representatives' contact with customers through their sales activities, a promising customer group extraction means that classifies customers into clusters based on the information stored in the customer information storage means and extracts, as promising clusters, clusters with a large number of customers that fit a correct customer model input to a correct customer model definition means, a promising customer identification means that quantifies a degree to which each customer is close to the correct customer model and assigns each customer a score, and a result output means that displays the customers for each cluster in order of highest score and indicates promising clusters.

As the world demands value creation that does not end with a single company or a single project, such as social issues, corporate needs are diversifying, and in considering the continuation of a company's business by contributing to society and the earth through solving social issues, it has become essential to suggest new proposal destinations in a way that enhances the value of sales proposals by combining sales activity information and information within other companies across cross-domains such as industry and finance, and connecting the interests of each field and company. Therefore, B2B sales also need to come up with new proposal ideas to meet these needs.

Meanwhile, when it comes to solving social or global issues, there are few cases where the issues can be solved in a closed manner within a single field, or the scale is small. Therefore, it is necessary to design and propose values that span a plurality of fields by expanding the scope of current business into other fields or by combining existing fields, but organizational thinking is difficult. Therefore, there are problems in which it is difficult to come up with ideas depending on business, or it takes a long time to search all the information.

### SUMMARY OF THE INVENTION

An object of the invention is to improve the efficiency of idea proposal support.

A proposal support system according to one aspect of the invention disclosed herein is a proposal support system including a processor that executes a program, and a storage device that stores the program, in which the processor is configured to execute: an acquisition process for acquiring a specific first word from a co-occurrence network in which each first word of a first word group in a first sentence group including a first field name in at least one information source out of a first information source related to a first field and a second information source related to a second field different from the first field is a node, and a co-occurrence relationship between two first words is a link connecting the nodes; an extraction process for extracting company names in the second field related to the specific first word, from a second sentence group including a second field name and the specific first word acquired in the acquisition process, from the at least one information source; an analysis process for, based on occurrence information regarding a specific second word that co-occurs with the specific first word in a second word group in the second sentence group, associating the specific first word, the specific second word, and the company names in the second field extracted by the extraction process; and an output process for outputting an analysis result from the analysis process in a displayable manner.

According to a representative embodiment of the invention, it is possible to improve the efficiency of idea proposal support. The problems, configurations, and effects other than those described above will be clarified by the description of the following embodiments.

### BRIEF DESCRIPTION OF THE DRAWINGS

FIG. 1 is an explanatory diagram showing an example of a system configuration of a network system;

FIG. 2 is a block diagram showing a hardware configuration example of a proposal support system;

FIG. 3 is an explanatory diagram showing an example of an own company DB;

FIG. 4 is an explanatory diagram showing an example of a company information DB;

FIG. 5 is a flowchart showing an example of a procedure for a cross-domain proposal support process;

FIG. 6 is a flowchart showing an example of detailed processing procedures of a co-occurrence network generation process (step S501);

FIG. 7 is an explanatory diagram showing an example of a crawling information DB;

FIG. 8 is an explanatory diagram showing an example of a co-occurrence probability table;

FIG. 9 is an explanatory diagram showing an example of a word occurrence count table;

FIG. 10 is an explanatory diagram showing an example of a co-occurrence network table;

FIG. 11 is an explanatory diagram showing an example of a co-occurrence network;

FIG. 12 is a flowchart showing an example of detailed processing procedures of a process for extracting names of companies that focus on a trending word in a second field (step S504);

FIG. 13 is an explanatory diagram showing a storage example of a second crawling result;

FIG. 14 is a flowchart showing an example of detailed processing procedures of a focus word analysis process (step S505);

FIG. 15 is an explanatory diagram showing an example of a co-occurrence probability analysis table;

FIG. 16 is an explanatory diagram showing an example of an occurrence count analysis table;

FIG. 17 is an explanatory diagram showing an example of a focusing company count analysis table;

FIG. 18 is an explanatory diagram showing an analysis result display screen example 1;

FIG. 19 is an explanatory diagram showing an analysis result display screen example 2; and

FIG. 20 is an explanatory diagram showing an analysis result display screen example 3.

### DESCRIPTION OF EMBODIMENTS

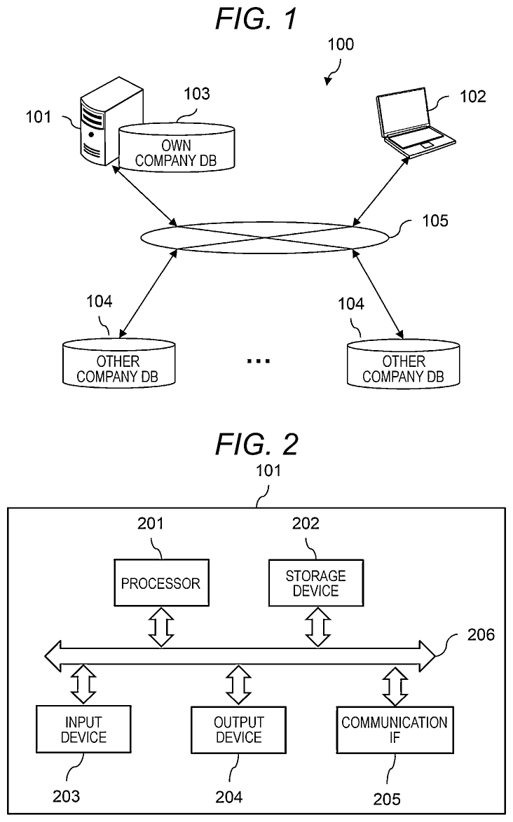

### <FIG. 1 Network System>

FIG. 1 is an explanatory diagram showing an example of a system configuration of a network system. A network system 100 includes a proposal support system 101 and a terminal 102. The proposal support system 101 and the terminal 102 are communicatively connected via a network 105 such as the Internet, a Local Area Network (LAN), or a Wide Area Network (WAN).

The proposal support system 101 is composed of one or more computers. The proposal support system 101 is connected to an own company Data Base (DB) 103. The own company DB 103 is a database that stores information about the own company, and stores document data related to research and development, prototyping, sales, marketing, production, quality, and sales, for example. The document data includes text files and web pages. The own company is a company that is a cross-domain proposal support target, for example, a company that owns a computer on which the proposal support system 101 is mounted.

The proposal support system 101 can also access an other company DB 104 via the network 105. The other company DB 104 is a database of other companies other than the own company, and like the own company DB 103, stores document data related to research and development, prototyping, sales, marketing, production, quality, and sales, for example. The other companies may be customers of the own company, or companies other than customers. When there is no distinction between the own company and the other companies, they are simply referred to as companies.

The terminal 102 has a browser function, and displays display information on a display screen when receiving visualization information from the proposal support system 101. A user may operate the proposal support system 101 directly, or may operate the proposal support system 101 via the terminal 102.

### <FIG. 2 Hardware Configuration Example of Proposal Support System 101>

FIG. 2 is a block diagram showing a hardware configuration example of a proposal support system 101. The proposal support system 101 includes a processor 201, a storage device 202, an input device 203, an output device 204, and a communication interface (communication IF) 205. The processor 201, the storage device 202, the input device 203, the output device 204, and the communication IF 205 are connected by a bus 206. The processor 201 controls the proposal support system 101. The storage device 202 is the working area of the processor 201. The storage device 202 is a non-temporary or temporary recording medium that stores various programs and data. Examples of the storage device 202 include a read only memory (ROM), a random access memory (RAM), a hard disk drive (HDD), and a flash memory. The input device 203 inputs data. Examples of the input device 203 include a keyboard, a mouse, a touch panel, a numeric keypad, a scanner, a microphone, and a sensor. The output device 204 outputs data. Examples of the output device 204 include a display, a printer, and a speaker. The communication IF 205 is connected to the network 105 and transmits and receives data.

The proposal support system 101 is composed of one or more computers. Therefore, the system has one or more processors 201, storage devices 202, input devices 203, output devices 204, and communication IFs 205. The proposal support system 101 may also include the terminal 102.

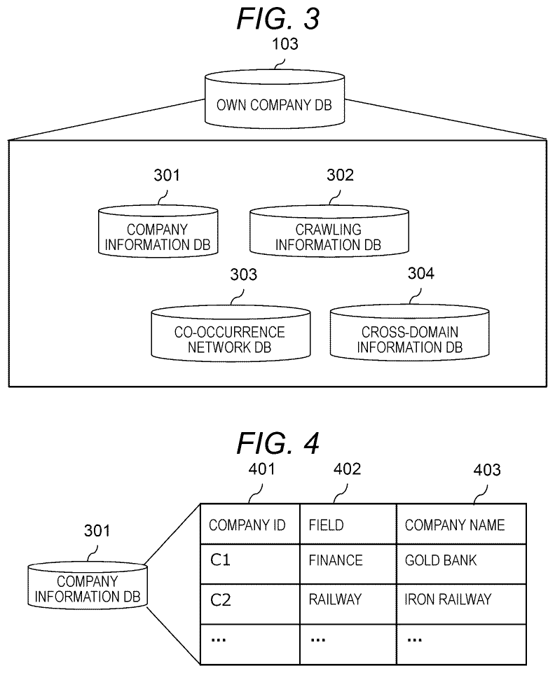

### <FIG. 3: Own Company DB 103>

FIG. 3 is an explanatory diagram showing an example of the own company DB 103. The own company DB 103 is configured by, for example, the storage device 202, and includes a company information DB 301, a crawling information DB 302, a co-occurrence network DB 303, and a cross-domain information DB 304. The crawling information DB 302, the co-occurrence network DB 303, and the cross-domain information DB 304 are databases generated by the proposal support system 101.

### <FIG. 4: Company Information DB 301>

FIG. 4 is an explanatory diagram showing an example of the company information DB 301. The company information DB 301 is a database that stores information about companies. The company information DB 301 has fields of company ID 401, field 402, and company name 403. The company ID 401 is identification information that uniquely identifies a company. The field 402 is the range of business that the company handles, and is classified, for example, by an industrial classification code. The company name 403 is the name of the company.

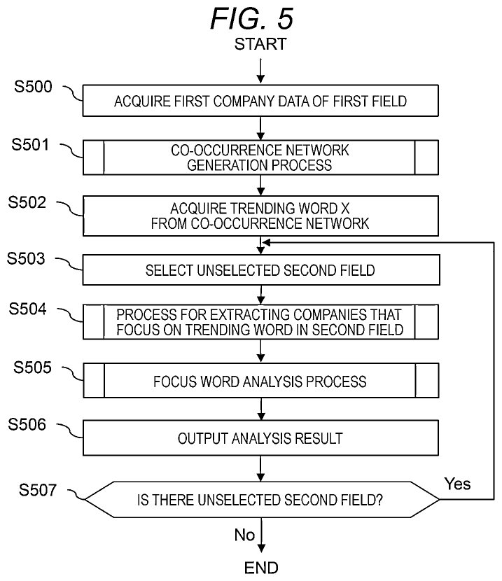

### <FIG. 5 Cross-Domain Proposal Support Process>

FIG. 5 is a flowchart showing an example of a procedure for a cross-domain proposal support process.

### (Step S500)

The proposal support system 101 acquires first company data of the first field and proceeds to step S501. The first field is the field 402 that the first company handles as its business. The first company is a company that handles the first field as its business. The first company data includes the company ID 401, the field 402, and the company name 403.

### (Step S501)

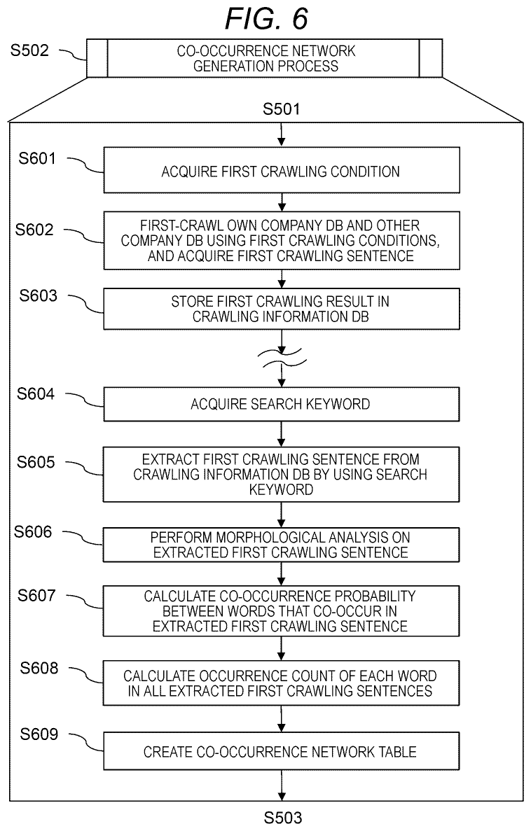

The proposal support system 101 executes a co-occurrence network generation process and proceeds to step S502. The co-occurrence network generation process is a process for generating a co-occurrence network. The co-occurrence network is a network in which words that co-occur in one sentence are nodes and co-occurrence relationships are links. The co-occurrence network is stored in the own company DB 103 and displayed on a display, which is an example of the output device 204.

[FIG. 6 Co-occurrence Network Generation Process (step S501)]

FIG. 6 is a flowchart showing an example of detailed processing procedures of a co-occurrence network generation process (step S501).

### (Step S601)

The proposal support system 101 acquires a first crawling condition and proceeds to step S602. The first crawling condition is a crawling word, a crawling period, and the first field acquired in step S500. The proposal support system 101 receives input of crawling words and crawling period by the user operating the input device 203.

The crawling words are one or more words used for crawling. The crawling words include the company name 403 in the first field. When the crawling words are composed of a plurality of words, the crawling words are combined with the company name 403 of the first field under an AND condition. When there are a plurality of words other than the company name 403 of the first field, the plurality of words may be combined under an AND condition, an OR condition, or a condition that contains both AND and OR conditions.

The crawling period is the range of the publication date (or the last update date when there is an update) of the document data to be crawled. The document data includes document files, web pages, and intra pages within and outside the own company. The sentence data includes sales-related information such as marketing information for each field, weekly sales reports, and sales memos obtained from conversations with customers, as well as manufacturing-related information such as complaints about products.

### (Step S602)

The proposal support system 101 crawls at least one of the own company DB 103 or the other company DB 104 using the first crawling condition acquired in step S601 (hereinafter, the first crawling), and acquires sentences corresponding to the crawling words (hereinafter, the first crawling sentences) from the document data that has been first-crawled. Then, the process proceeds to step S603.

The first crawling sentence is composed of one or more phrases. Specifically, for example, when a sentence configuring a certain paragraph in the document data of the own company DB 103 and the other company DB 104 includes the crawling word, the sentence is extracted as the first crawling sentence.

Further, when a certain phrase in the document data of the own company DB 103 and the other company DB 104 contains the crawling word, the phrase is extracted as the first crawling sentence. In this case, the phrase containing the crawling word and a predetermined number of phrases before and after the phrase may be the first crawling sentence. The predetermined number can be arbitrarily set and changed in the proposal support system 101. The predetermined number of phrases before and after the phrase may not include the crawling word.

### (Step S603)

The proposal support system 101 stores the first crawling result in the crawling information DB 302 and proceeds to step S604.

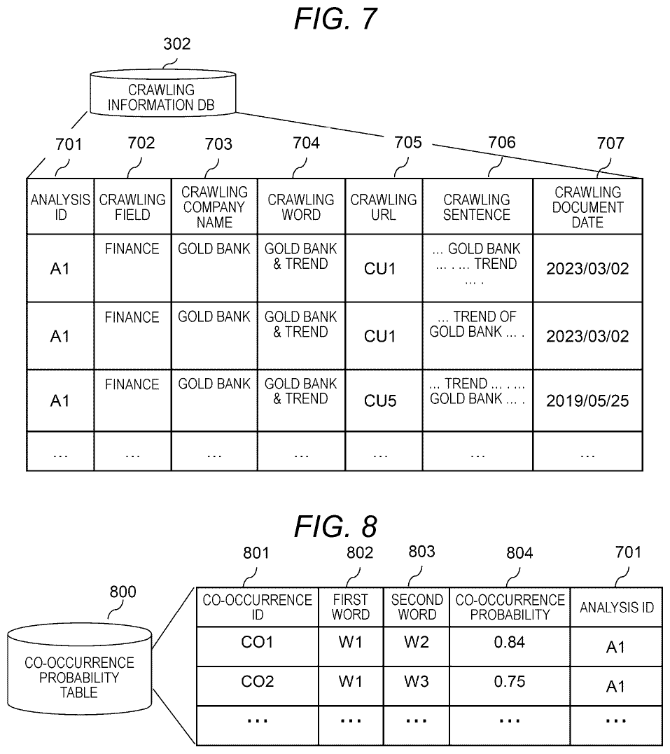

### [FIG. 7 Crawling Information DB 302]

FIG. 7 is an explanatory diagram showing an example of the crawling information DB 302. The crawling information DB 302 has fields of analysis ID 701, crawling field 702, crawling company name 703, crawling word 704, crawling URL 705, crawling sentence 706, and crawling document date 707. A combination of the value of each field in the same row is an entry indicating one first crawling result.

The analysis ID 701 is identification information that uniquely identifies the analysis. For example, an analysis ID 701 is assigned to each cross-domain proposal support. In the present example, “A1” is assigned. When a plurality of crawling sentences 706 are extracted in one crawling, entries with the same analysis ID 701 are registered in the same number as the extracted crawling sentences 706. For example, when three crawling sentences 706 are extracted in the first crawling A1, three entries with analysis ID 701 “A1” are registered.

The crawling field 702 is the field 402 to be crawled. In the case of the first crawling A1 described above, the crawling field 702 is the field 402 “finance”.

The crawling company name 703 is the company name 403 to be crawled. In the case of the first crawling A1 described above, the crawling company name 703 is the company name 403 “Gold Bank” of which field 402 is “finance”.

The crawling word 704 is a word used for crawling. In the case of the first crawling A1 described above, the crawling word 704 is the crawling word “Gold Bank & Trend” included in the first crawling condition acquired in step S601 (“&” is an AND condition).

The crawling URL 705 is the Uniform Resource Locator (URL) of the crawling destination by the crawling word 704.

The crawling sentence 706 is a sentence including the crawling word 704 extracted by crawling by the crawling word 704. In the case of the first crawling A1 described above, the crawling sentence 706 is the first crawling sentence.

The crawling document date 707 is the publication date of the crawled document data (the last update date when there is an update).

### (Step S604)

Returning to FIG. 6, the proposal support system 101 acquires a search keyword and proceeds to step S605. Specifically, for example, the proposal support system 101 receives the input of the search keyword by the user operating the input device 203. The search keyword is one or more words. The search keyword may include the field 402 or the company name 403. When the search keyword is composed of a plurality of words, the plurality of words may be combined under an AND condition, an OR condition, or a condition that combines an AND condition and an OR condition.

### (Step S605)

The proposal support system 101 extracts the first crawling sentence from the crawling information DB 302 by using the search keyword acquired in step S604, and proceeds to step S606. Specifically, for example, the proposal support system 101 extracts the first crawling sentence that matches the search keyword from the crawling sentence 706. The extracted first crawling sentence is referred to as the “extracted first crawling sentence”.

### (Step S606)

The proposal support system 101 performs morphological analysis on the extracted first crawling sentence in step S605 to break the first crawling sentence down into words, retains the words corresponding to nouns, and proceeds to step S607.

### (Step S607)

The proposal support system 101 calculates the co-occurrence probability between words that co-occur in the extracted first crawling sentence, creates a co-occurrence probability table, and proceeds to step S608. Specifically, for example, when the extracted first crawling sentence is composed of a plurality of phrases, the proposal support system 101 may calculate the co-occurrence probability between words (hereinafter, the first co-occurrence probability) for words that co-occur in all the plurality of phrases, or may calculate the co-occurrence probability between words (hereinafter, the second co-occurrence probability) for words that co-occur in each of the plurality of phrases. Which of the first co-occurrence probability or the second co-occurrence probability to be adopted can be set and changed in the proposal support system 101. When there is no distinction between the first co-occurrence probability and the second co-occurrence probability, they are simply referred to as co-occurrence probabilities.

### [FIG. 8 Co-occurrence Probability Table]

FIG. 8 is an explanatory diagram showing an example of a co-occurrence probability table. A co-occurrence probability table 800 is stored in the co-occurrence network DB 303. The co-occurrence probability table 800 has fields of a co-occurrence ID 801, a first word 802, a second word 803, a co-occurrence probability 804, and an analysis ID 701. The co-occurrence ID 801 is identification information that uniquely identifies a co-occurrence relationship. The first word 802 is one of two words that have a co-occurrence relationship. The second word 803 is the other of two words that have a co-occurrence relationship. The co-occurrence probability 804 is the probability that the first word 802 and the second word 803 co-occur in the extracted first crawling sentence.

When the co-occurrence probability 804 is the first co-occurrence probability, it is calculated by the following Expression (1).

$$Co - occurrence probability = ( number of sentences in which the first word 802 and the second word 803 occur ) / ( number of sentences in which the first word 802 or the second word 803 occurs ) \qquad ( 1 )$$

When the co-occurrence probability 804 is the second co-occurrence probability, it is calculated by the following Expression (2).

$$Co - occurrence probability = ( number of phrases in which the first word 802 and the second word 803 occur ) / ( number of phrases in which the first word 802 or the second word 803 occurs ) \qquad ( 2 )$$

### (Step S608)

Returning to FIG. 6, the proposal support system 101 calculates the occurrence count of each word in all extracted first crawling sentences to create a word occurrence count table, and proceeds to step S609.

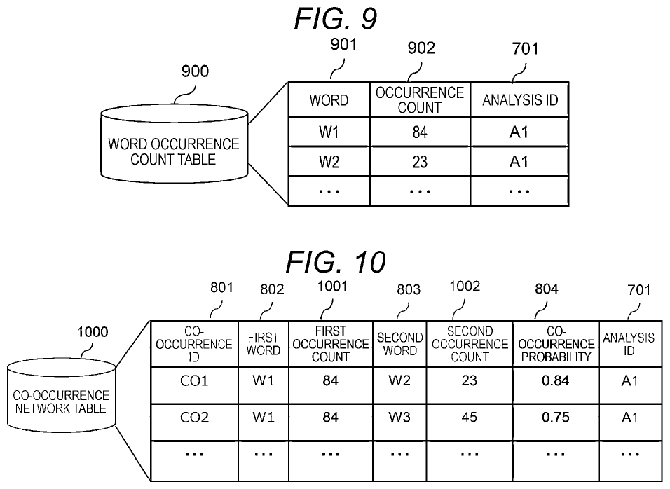

### [FIG. 9 Word Occurrence Count Table]

FIG. 9 is an explanatory diagram showing an example of a word occurrence count table. A word occurrence count table 900 is stored in the co-occurrence network DB 303. The word occurrence count table 900 has fields of word 901, occurrence count 902, and analysis ID 701. The word 901 is a word contained in the extracted first crawling sentence. The occurrence count 902 is the occurrence count of the word 901 in all extracted first crawling sentences.

### (Step S609)

Returning to FIG. 6, the proposal support system 101 creates a co-occurrence network table, generates a co-occurrence network, displays the generated co-occurrence network on the display, and proceeds to step S502.

### [FIG. 10 Co-Occurrence Network Table]

FIG. 10 is an explanatory diagram showing an example of a co-occurrence network table. A co-occurrence network table 1000 is stored in the co-occurrence network DB 303. The co-occurrence network table 1000 has fields of co-occurrence ID 801, first word 802, first occurrence count 1001, second word 803, second occurrence count 1002, co-occurrence probability 804, and analysis ID 701. The first occurrence count 1001 is the occurrence count 902 when the word 901 is the first word 802. The second occurrence count 1002 is the occurrence count 902 when the word 901 is the second word 803.

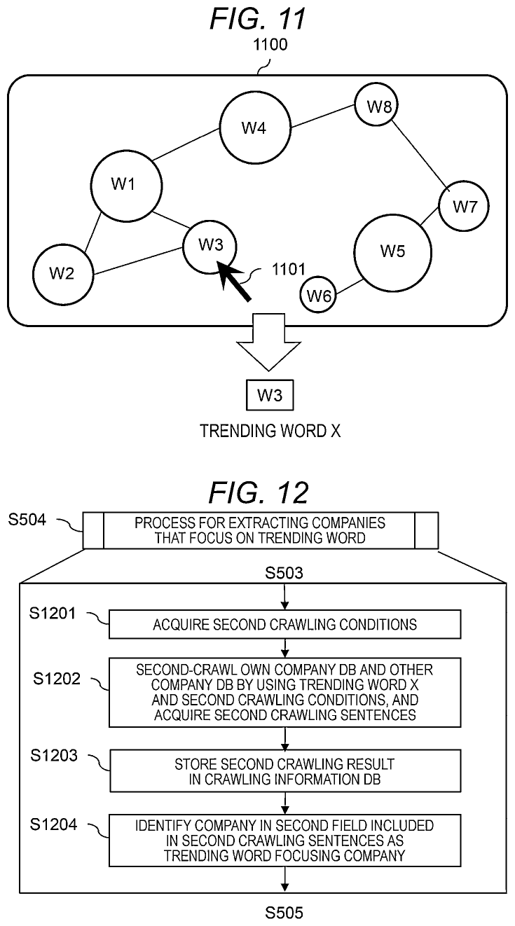

### [FIG. 11 Co-Occurrence Network]

FIG. 11 is an explanatory diagram showing an example of a co-occurrence network. A co-occurrence network 1100 is created based on the co-occurrence network table 1000. The co-occurrence network 1100 is composed of a plurality of nodes (circular shapes) and links (line segments) connecting two nodes. The nodes correspond to the first word 802 or the second word 803. The links indicate a co-occurrence relationship. The size of the node corresponds to the occurrence count 902. The larger the node, the greater the occurrence count 902.

### (Step S502)

Returning to FIG. 5, the proposal support system 101 acquires a trending word X from the co-occurrence network 1100 and proceeds to step S504. Specifically, for example, the proposal support system 101 acquires, as the trending word X, the word corresponding to the node selected by the user operating the input device 203 from the co-occurrence network 1100. In FIG. 11, the node indicating a word W3 is selected by a cursor 1101, and thus the word W3 is acquired as the trending word X.

### (Step S503)

The proposal support system 101 selects an unselected second field (step S503). The second field is a field different from the first field. In other words, a field 402 other than the field 402 indicating the name of the first field acquired in step S501 becomes the second field. For example, when the first field is “finance”, the second field is one or more fields such as “railway”, “service industry”, “manufacturing”, or the like. The proposal support system 101 selects a field 402 indicating the name of an unselected second field from one or more second fields.

### (Step S504)

The proposal support system 101 executes a process for extracting names of companies that focus on the trending word in the second field. The process for extracting names of companies that focus on the trending word in the second field (step S504) is a process for extracting company names 403 of companies in the second field that focus on the trending word X acquired in step S502. Specifically, for example, the process for extracting names of companies that focus on the trending word in the second field (step S504) is a process for extracting company names 403 of companies (specified by the company ID 401 corresponding to the field 402) indicating the second field related to the trending word X.

[FIG. 12 Process for Extracting Names of Companies that Focus on Trending Word in Second Field (Step S504)]

FIG. 12 is a flowchart showing an example of detailed processing procedures of a process for extracting names of companies that focus on a trending word in a second field (step S504).

### (Step S1201)

The proposal support system 101 acquires a second crawling condition and proceeds to step S1202. The first crawling condition is the crawling period and the field 402 of the second field selected in step S503. The proposal support system 101 receives the input of the crawling period, for example, by the user operating the input device 203.

### (Step S1202)

The proposal support system 101 crawls at least one of the own company DB 103 and the other company DB 104 by using the trending word X and the second crawling condition (hereinafter, the second crawling), and acquires the second crawling sentences. Specifically, for example, the proposal support system 101 may perform the second crawling of document data within the crawling period using the trending word X as the crawling word 704, or may perform the second crawling of document data within the crawling period by combining the trending word X and the second field with an AND condition and using the combination as the crawling word 704.

The proposal support system 101 may crawl a company DB of the first field of the own company DB 103 and the other company DBs 104, or may crawl the company DB of the second field, or may crawl the own company DB 103 and the other company DBs 104. Further, the proposal support system 101 may perform the second crawling on a company DB different from the company DB on which the first crawling is performed.

### (Step S1203)

The proposal support system 101 stores the second crawling result in the crawling information DB 302 and proceeds to step S1204.

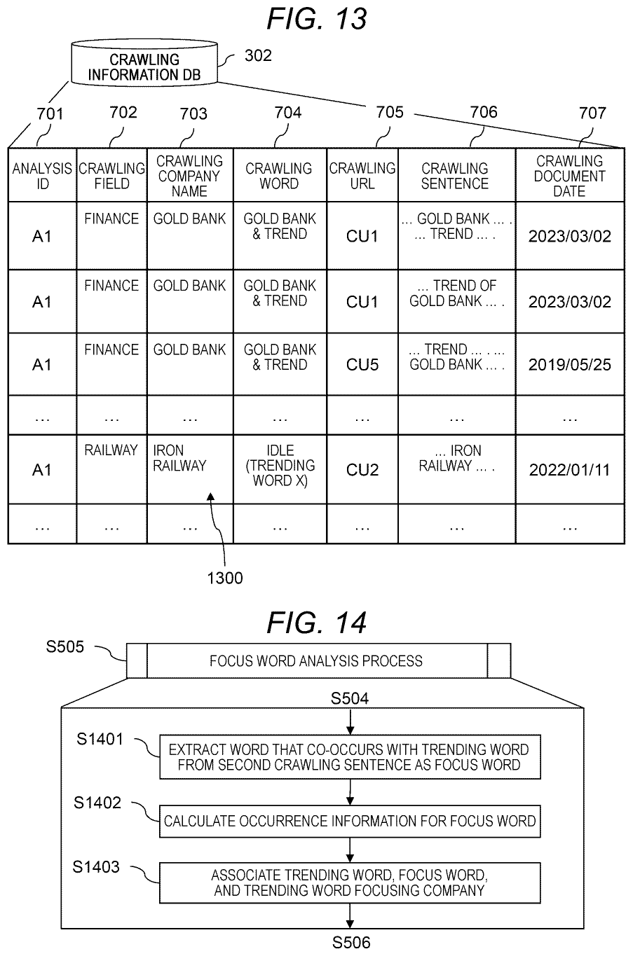

### [FIG. 13 Storage Example of Second Crawling Result]

FIG. 13 is an explanatory diagram showing a storage example of the second crawling result. In FIG. 13, entry 1300 is added to the crawling information DB 302 as the second crawling result. In the entry 1300, “idle” is stored as the trending word X.

### (Step S1204)

Returning to FIG. 12, the proposal support system 101 identifies the company in the second field included in the second crawling sentence as the trending word focusing company name, and proceeds to step S505. The second crawling sentence is the crawling sentence 706 in the second crawling result (for example, entry 1300). The company in the second field is the crawling company name 703 in the crawling field 702 in the second crawling result (for example, entry 1300). In the example of FIG. 13, “Iron Railway” is identified as the trending word focusing company name.

### (Step S505)

Returning to FIG. 5, the proposal support system 101 executes a focus word analysis process. The focus word analysis process (step S505) is a process for identifying the focus word. The focus word is a word that co-occurs with the trending word.

[FIG. 14 Focus Word Analysis Process (step S505)]

FIG. 14 is a flowchart showing an example of detailed processing procedures of a focus word analysis process (step S505).

### (Step S1401)

The proposal support system 101 extracts a word that co-occurs with the trending word from the second crawling sentence as a focus word. When extracting a trending word and a focus word from the second crawling sentence on a phrase-by-phrase basis, at least one of the preceding and succeeding phrases may be included in the extraction target. The focus words are stored in the cross-domain information DB 304.

### (Step S1402)

The proposal support system 101 calculates occurrence information for the focus word extracted in step S1401. The occurrence information for the focus word is information indicating how often the focus word or words related to the focus word occurred. Specifically, the occurrence information for the focus word is, for example, the co-occurrence probability between the trending word and the focus word, the occurrence count of the focus word, and the company name 403 of the trending word focusing company name. The proposal support system 101 can set at least one of the co-occurrence probability between the trending word and the focus word, the occurrence count of the focus word, and the company name 403 of the trending word focusing company name as the occurrence information for the focus word.

The co-occurrence probability between the trending word and the focus word is calculated by applying the above-described Expression (1) or Expression (2) to the second crawling sentence (crawling sentence 706 in the second crawling result (for example, entry 1300)). The occurrence count of the focus word is the number of times the focus word occurs in the second crawling sentence. The company name 403 of the trending word focusing company name is the crawling company name 703 (for example, “Iron Railway”) in the second crawling result (for example, entry 1300). The occurrence information for the focus word is stored in the cross-domain information DB 304.

### (Step S1403)

The proposal support system 101 associates the trending word, the focus word, and the trending word focusing company name. The information indicating the association is stored in the cross-domain information DB 304. Thereafter, the process proceeds to step S506.

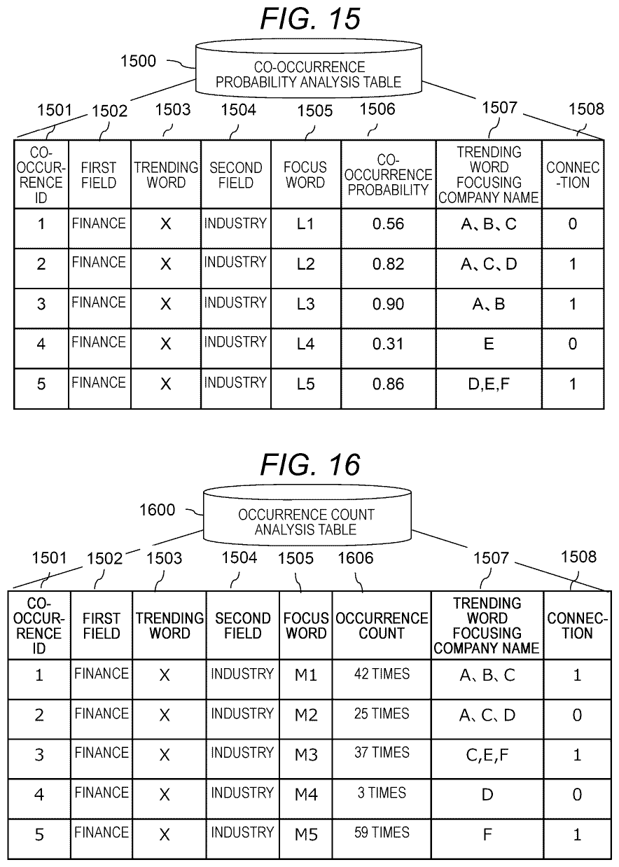

### [FIGS. 15 to 17 Cross-Domain Information DB 304]

Here, a specific storage example in the cross-domain information DB 304 in the focus word analysis process (step S505) will be described with reference to FIGS. 15 to 17.

### [FIG. 15 Co-Occurrence Probability Analysis Table]

FIG. 15 is an explanatory diagram showing an example of a co-occurrence probability analysis table 1500. The co-occurrence probability analysis table 1500 is generated when the occurrence information for the focus word is a co-occurrence probability. The co-occurrence probability analysis table 1500 has fields of co-occurrence ID 1501, first field 1502, trending word 1503, second field 1504, focus word 1505, co-occurrence probability 1506, trending word focusing company name 1507, and connection 1508.

The co-occurrence ID 1501 is identification information that uniquely identifies a combination of a trending word and a focus word. The first field 1502 is the field 402 that the first company handles as its business. The first company is a company that handles the first field as its business.

The trending word 1503 is a word acquired in step S502. The second field 1504 is a field different from the first field 1502. The focus word 1505 is a word identified in step S505.

The co-occurrence probability 1506 is the probability that the trending word 1503 and the focus word 1505 co-occur in the second crawling sentence (the crawling sentence 706 in the second crawling result (for example, the entry 1300)). The trending word focusing company name 1507 is the company name 403 of the trending word focusing company name.

The connection 1508 is information indicating whether there is a connection between the trending word 1503, the focus word 1505, and the trending word focusing company name 1507. “1” indicates connection, and “0” indicates no connection. In step S1403, the proposal support system 101 sets the value of the connection 1508 to “1” for entries of which co-occurrence probability 1506 is the threshold or greater, and sets the value of the connection 1508 to “0” for entries of which co-occurrence probability 1506 is not the threshold or greater.

In addition, instead of the threshold, the proposal support system 101 may set the value of the connection 1508 to “1” for entries ranked 1 to n (n is any integer of 1 or greater) in descending order of the co-occurrence probability 1506, and set the value of the connection 1508 to “0” for entries ranked n+1 and after.

### [FIG. 16 Co-Occurrence Probability Analysis Table]

FIG. 16 is an explanatory diagram showing an example of an occurrence count analysis table 1600. The occurrence count analysis table 1600 is generated when the occurrence information regarding the focus word is the occurrence count of the focus word.

The occurrence count analysis table 1600 is a table in which the co-occurrence probability 1506 of the co-occurrence probability analysis table 1500 has been changed to the occurrence count 1606. The occurrence count 1606 is the number of times the focus word 1505 has occurred in the second crawling sentence.

In step S1403, the proposal support system 101 sets the value of the connection 1508 to “1” for entries of which occurrence count 1606 is the threshold or greater, and sets the value of the connection 1508 to “0” for entries of which occurrence count 1606 is not the threshold or greater.

In addition, instead of the threshold, the proposal support system 101 may set the value of the connection 1508 to “1” for entries ranked 1 to n in descending order of the occurrence count 1606, and set the value of the connection 1508 to “0” for entries ranked n+1 and after.

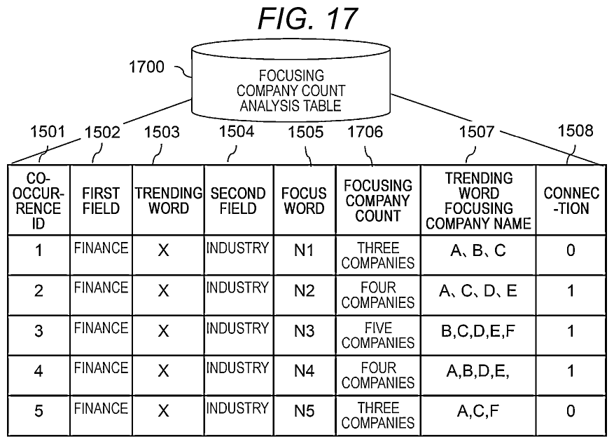

### [FIG. 17 Focusing Company Count Analysis Table]

FIG. 17 is an explanatory diagram showing an example of a focusing company count analysis table 1700. The focusing company count analysis table 1700 is generated when the occurrence information regarding the focus word is the company name 403 of the trending word focusing company name.

The focusing company count analysis table 1700 is a table in which the co-occurrence probability 1506 of the co-occurrence probability analysis table 1500 is changed to the focusing company count 1706. The focusing company count 1706 is the number of companies that focus on the trending word, and specifically, for example, the number of trending word focusing company names 1507.

In step S1403, the proposal support system 101 sets the value of the connection 1508 to “1” for entries of which focusing company count 1706 is the threshold or greater, and sets the value of the connection 1508 to “0” for entries of which focusing company count 1706 is not the threshold or greater.

In addition, instead of the threshold, the proposal support system 101 may set the value of the connection 1508 to “1” for entries ranked 1 to n in descending order of the focusing company count 1706, and set the value of the connection 1508 to “0” for entries ranked n+1 and after.

### (Step S506)

Returning to FIG. 5, the proposal support system 101 outputs the analysis result in a displayable manner on the display which is an example of the output device 204 of the proposal support system 101 or the display of the terminal 102. The analysis result includes the first field 1502, the trending word 1503, the second field 1504, the focus word 1505, the trending word focusing company name 1507, and a connection relationship indicating the connection 1508 between the trending word 1503, the focus word 1505, and the trending word focusing company name 1507.

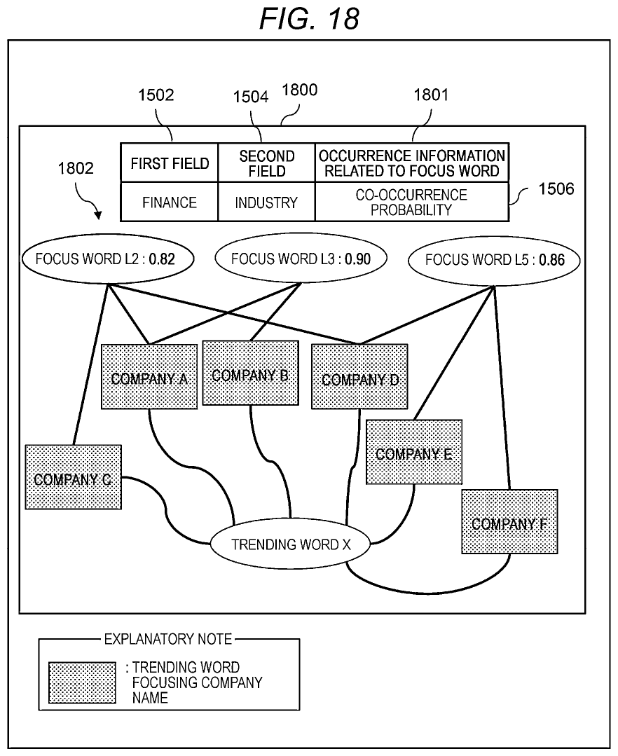

### [FIG. 18 to FIG. 20 Analysis Result Display Screen]

Here, display screen examples in which the analysis results are displayed will be described with reference to FIG. 18 to FIG. 20.

### [FIG. 18 Analysis Result Display Screen Example 1]

FIG. 18 is an explanatory diagram showing an analysis result display screen example 1. The analysis result display screen 1800 is an example of a screen in which the occurrence information 1801 related to the focus word is the co-occurrence probability 1506. Specifically, for example, the analysis result display screen 1800 displays the first field 1502, the second field 1504, and the co-occurrence probability 1506 as the analysis results.

The analysis result display screen 1800 also displays a connection relationship graph 1802 showing the connection 1508 between the trending word 1503, the focus word 1505, and the trending word focusing company name 1507 as the analysis result. The connection relationship graph 1802 is a graph in which the trending word 1503, the focus word 1505, and the trending word focusing company name 1507, which have a connection 1508 of “1”, are nodes, and the trending word 1503 and the focus word 1505 are connected via the trending word focusing company name 1507.

The bold text in the node showing the focus word 1505 is the co-occurrence probability 1506 between the focus word 1505 and the trending word 1503. For example, the co-occurrence probability 1506 between X representing the trending word 1503 and L2 representing the focus word 1505 is “0.90”.

By referring to the analysis result display screen 1800, when the trending word X in “finance” in the first field 1502 is considered, it is found that the cross-domain that is most compatible with the first company in the first field 1502 is trending word focusing companies A and B, which focus on focus word L3 with the highest co-occurrence probability 1506 with the trending word X, among trending word focusing companies A to F dealing with “industry” in the second field 1504.

Therefore, the proposal support system 101 can suggest to the first company in the first field 1502 a proposal or consideration regarding the focus word L3 for the trending word X to the trending word focusing companies A and B that deals with “industry” in the second field 1504 and focus on the focus word L3 with the highest co-occurrence probability 1506 with the trending word X.

For example, when the trending word X is “idle”, the first company (crawling company name 703) in the first field 1502 is “Gold Bank”, and the focus word L3 is “large-scale energy storage equipment”, the proposal support system 101 can suggest to the first company “Gold Bank” in the first field 1502, a proposal or consideration regarding the focus word L3 “large-scale energy storage equipment” for the trending word X “idle” to the trending word focusing companies A and B that focus on the focus word L3 “large-scale energy storage equipment” that has the highest co-occurrence probability 1506 with the trending word X “idle”.

The high co-occurrence probability 1506 indicates the high interest in the focus word L3 that co-occurs with the trending word X. Therefore, the proposal support system 101 can estimate, by cross-domain, the effectiveness of a proposal or consideration for the focus word L3 “large-scale energy storage equipment” from the first company “Gold Bank” dealing with the first field 1502 corresponding to the co-occurrence network 1100 from which the trending word X “idle” is selected to the trending word focusing companies A and B dealing with the second field 1504 related to the focus word L3 “large-scale energy storage equipment”.

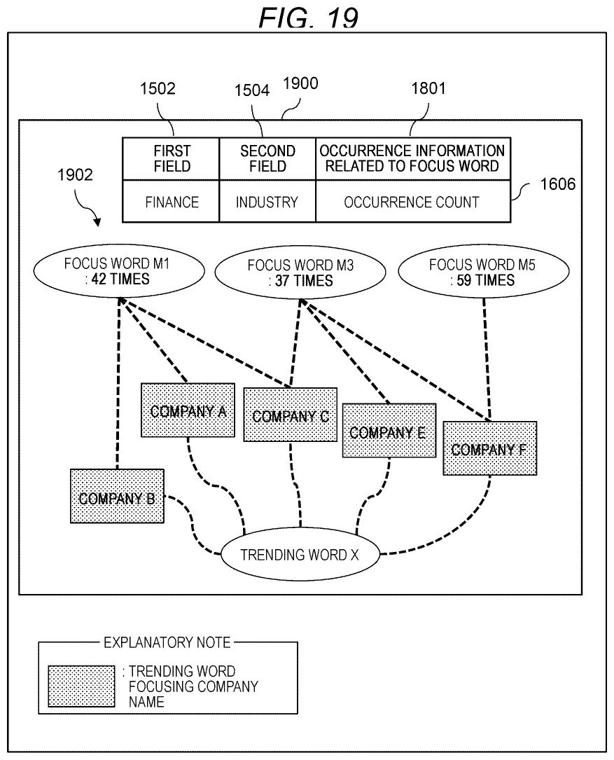

### [FIG. 19 Analysis Result Display Screen Example 2]

FIG. 19 is an explanatory diagram showing an analysis result display screen example 2. The analysis result display screen 1900 is an example of a screen when the occurrence information 1801 related to the focus word is the occurrence count 1606. Specifically, for example, the analysis result display screen 1900 displays the first field 1502, the second field 1504, and the occurrence count 1606 as the analysis results.

The analysis result display screen 1900 also displays a connection relationship graph 1902 showing the connection 1508 between the trending word 1503, the focus word 1505, and the trending word focusing company name 1507 as the analysis result. The connection relationship graph 1902 is a graph in which the trending word 1503, the focus word 1505, and the trending word focusing company name 1507, which have a connection 1508 of “1”, are nodes, and the trending word 1503 and the focus word 1505 are connected via the trending word focusing company name 1507.

The bold text in the node showing the focus word 1505 is the occurrence count 1606 of the focus word 1505. For example, the occurrence count 1606 of Ml showing the focus word 1505 is “42 times”.

By referring to the analysis result display screen 1900, when the trending word X in “finance” in the first field 1502 is considered, it is found that the cross-domain that is most compatible with the first company in the first field 1502 is a trending word focusing company F, which focuses on a focus word M5 with the highest occurrence count 1606, among trending word focusing companies A to C, E, and F dealing with “industry” in the second field 1504.

Therefore, the proposal support system 101 can suggest to the first company in the first field 1502 a proposal or consideration regarding the focus word M5 for trending word X to trending word focusing company F that deals with “industry” in the second field 1504 and focuses on the focus word M5 with the highest occurrence count 1606.

For example, when the trending word X is “idle”, the first company (crawling company name 703) in the first field 1502 is “Gold Bank”, and the focus word M5 is “unmanned store”, the proposal support system 101 can suggest to the first company “Gold Bank” in the first field 1502, a proposal or consideration regarding the focus word M5 “unmanned store” for the trending word X “idle” to the trending word focusing company F that focuses on the focus word M5 “unmanned store” with the highest occurrence count 1606.

The high occurrence count 1606 indicates the high interest in the focus word M5. Therefore, the proposal support system 101 can estimate, by cross-domain, the effectiveness of a proposal or consideration for the focus word M5 “unmanned store” from the first company “Gold Bank” dealing with the first field 1502 corresponding to the co-occurrence network 1100 from which the trending word X “idle” is selected to the trending word focusing company F dealing with the second field 1504 related to the focus word M5 “unmanned store”.

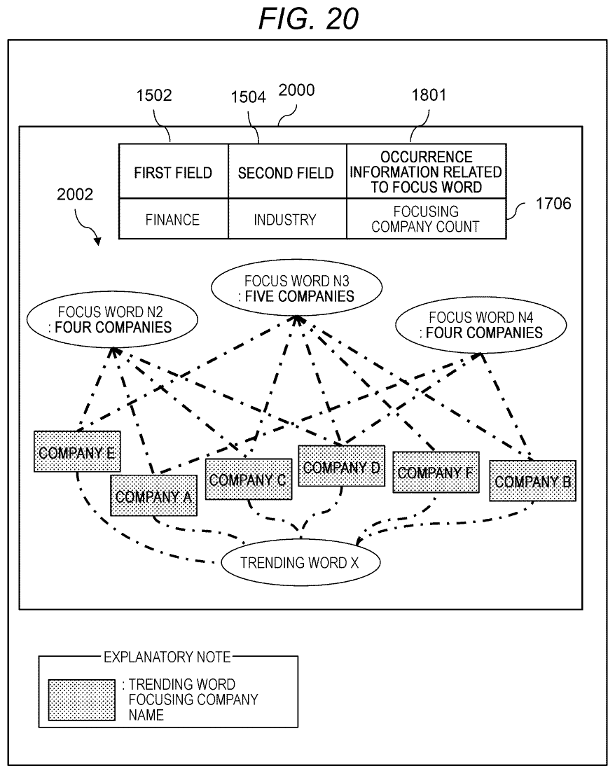

### [FIG. 20 Analysis Result Display Screen Example 3]

FIG. 20 is an explanatory diagram showing an analysis result display screen example 3. The analysis result display screen 2000 is an example of a screen when the occurrence information 1801 related to the focus word is the focusing company count 1706. Specifically, for example, the analysis result display screen 1900 displays the first field 1502, the second field 1504, and the focusing company count 1706 as the analysis result.

The analysis result display screen 1900 also displays a connection relationship graph 2002 showing the connection 1508 between the trending word 1503, the focus word 1505, and the trending word focusing company name 1507 as the analysis result. The connection relationship graph 2002 is a graph in which the nodes are the trending word 1503, the focus word 1505, and the trending word focusing company name 1507, each of which has a connection 1508 of “1,!” and the trending word 1503 and the focus word 1505 are connected via the trending word focusing company name 1507.

The bold text in the node showing the focus word 1505 is the focusing company count 1706 of the focus word 1505. For example, the focusing company count 1706 of N2 showing the focus word 1505 is “4 companies”.

By referring to the analysis result display screen 2000, when the trending word X in “finance” in the first field 1502 is considered, it is found that the cross-domain that is most compatible with the first company in the first field 1502 is the trending word focusing companies B to F, which focus on the focus word N3 with the largest focusing company count 1706, among trending word focusing companies A to F dealing with “industry” in the second field 1504.

Therefore, the proposal support system 101 can suggest to the first company in the first field 1502 a proposal or consideration regarding the focus word N3 for the trending word X to the trending word focusing companies B to F that deal with “industry” in the second field 1504 and focus on the focus word N3 with the largest occurrence count 1606.

For example, when the trending word X is “idle”, the first company (crawling company name 703) in the first field 1502 is “Gold Bank”, and the focus word N3 is “direct product sales”, the proposal support system 101 can suggest to the first company “Gold Bank” in the first field 1502, a proposal or consideration regarding the focus word N3 “direct product sales” for the trending word X “idle” to the trending word focusing companies B to F that focus on the focus word N3 “direct product sales” with the largest focusing company count 1706.

The large focusing company count 1706 indicates the high interest in the focus word M5. Therefore, the proposal support system 101 can estimate, by cross-domain, the effectiveness of a proposal or consideration for the focus word N3 “direct product sales” from the first company “Gold Bank” dealing with the first field 1502 corresponding to the co-occurrence network 1100 from which the trending word X “idle” is selected to the trending word focusing companies B to F dealing with the second field 1504 related to the focus word N3 “direct product sales”.

### (Step S507)

Returning to FIG. 5, the proposal support system 101 determines whether there is an unselected second field 1504. Specifically, for example, the proposal support system 101 determines whether there is an unselected second field 1504, from the field 402 of the company information DB 301. When there is an unselected second field 1504 (step S507: Yes), the proposal support system 101 selects one from the unselected second fields 1504 and returns to step S503. When there is no unselected second field 1504 (step S507: No), the series of processes ends. Note that step S506 may be executed after No in step S507.

In this way, according to the present embodiment, it is possible to improve the efficiency of idea proposal support. Specifically, as the world demands value creation that goes beyond the scope of a single company or a single project, such as social issues, it is possible to connect the interests of each field and company and suggest new proposals that increase the value of sales proposals, by combining sales activity information and external information by crossing different fields (cross-domain) such as industry and finance. This makes it possible to accelerate organizational ideas in cross-domain and efficiently materialize proposal stories.

It should be noted that the invention is not limited to the above-described embodiments, but includes various modification embodiments and equivalent structures within the scope of the appended claims. For example, the above-described embodiments have been described in detail in order to describe the invention in an easy-to-understand manner, and the invention is not necessarily limited to those having all the configurations described. In addition, a part of the configuration of an embodiment may be replaced by the configuration of another embodiment. Further, the configuration of another embodiment may be added to the configuration of an embodiment. Further, with respect to a part of the configuration of each embodiment, other configurations may be added, deleted, or replaced.

Further, each of the above-described configurations, functions, processing units, processing means and the like may be realized by hardware, for example, by designing a part or all of them with, for example, an integrated circuit, or may be realized by software by the processor interpreting and executing programs for realizing respective functions.

Information such as programs, tables, and files realizing each function can be stored in a storage device such as a memory, a hard disk, a solid state drive (SSD), or a recording medium such as an integrated circuit (IC) card, an SD card, and a digital versatile disc (DVD).

Further, the control lines and the information lines which are considered to be necessary for the description are indicated, and it does not necessarily indicate all control lines and information lines necessary for mounting. In fact, it may be considered that almost all constituent elements are interconnected.

What is claimed is:

1. A proposal support system comprising:
a processor that executes a program; and
a storage device that stores the program,
wherein the processor is configured to execute:
an acquisition process for acquiring a specific first word from a co-occurrence network in which each first word of a first word group in a first sentence group including a first field name in at least one information source out of a first information source related to a first field and a second information source related to a second field different from the first field is a node, and a co-occurrence relationship between two first words is a link connecting the nodes;
an extraction process for extracting company names in the second field related to the specific first word, from a second sentence group including a second field name and the specific first word acquired in the acquisition process, from the at least one information source;
an analysis process for, based on occurrence information regarding a specific second word that co-occurs with the specific first word in a second word group in the second sentence group, associating the specific first word, the specific second word, and the company names in the second field extracted by the extraction process; and
an output process for outputting an analysis result from the analysis process in a displayable manner.

2. The proposal support system according to claim 1, wherein
the processor
executes a generation process for generating the co-occurrence network based on the first sentence group, and
acquires, in the acquisition process, the specific first word from the co-occurrence network generated in the generation process.

3. The proposal support system according to claim 1,
wherein
in the analysis process, the processor calculates, as the occurrence information, a co-occurrence probability between the specific first word and the specific second word in the second sentence group, and associates the specific first word, the specific second word, and the company names in the second field, based on the co-occurrence probability.

4. The proposal support system according to claim 1, wherein
in the analysis process, the processor calculates, as the occurrence information, an occurrence count of the specific second word in the second sentence group, and associates the specific first word, the specific second word, and the company names in the second field, based on the occurrence count.

5. The proposal support system according to claim 1, wherein
in the analysis process, the processor calculates, as the occurrence information, the number of companies related to the specific first word in the second field in the second sentence group, and associates the specific first word, the specific second word, and the company names in the second field, based on the number of companies in the second field.

6. The proposal support system according to claim 1, wherein
in the output process, the processor outputs the first field name, the second field name, and the occurrence information, and outputs connection information in which the specific first word, the specific second word, and the company names in the second field are connected in a displayable manner.

7. The proposal support system according to claim 3, wherein
in the output process, the processor outputs the first field name, the second field name, and the co-occurrence probability, which is the occurrence information, and outputs a graph showing combinations of the specific first word and the specific second word connected based on the co-occurrence probability and the company names in the second field in a displayable manner.

8. The proposal support system according to claim 4, wherein
in the output process, the processor outputs the first field name, the second field name, and the occurrence count, which is the occurrence information, and outputs a graph showing combinations of the specific first word and the specific second word connected based on the occurrence count and the company names in the second field in a displayable manner.

9. The proposal support system according to claim 5, wherein
in the output process, the processor outputs the first field name, the second field name, and the number of companies in the second field, which is the occurrence information, and also outputs a graph showing combinations of the specific first word and the specific second word connected based on the number of companies in the second field, and the company names in the second field in a displayable manner.

10. A proposal support method executed by a proposal support system including a processor that executes a program, and a storage device that stores the program,
wherein the processor is configured to execute:
an acquisition process for acquiring a specific first word from a co-occurrence network in which each first word of a first word group in a first sentence group including a first field name in at least one information source out of a first information source related to a first field and a second information source related to a second field different from the first field is a node, and a co-occurrence relationship between two first words is a link connecting the nodes;
an extraction process for extracting company names in the second field related to the specific first word, from a second sentence group including a second field name and the specific first word acquired in the acquisition process, from the at least one information source;
an analysis process for, based on occurrence information regarding a specific second word that co-occurs with the specific first word in a second word group in the second sentence group, associating the specific first word, the specific second word, and the company names in the second field extracted by the extraction process; and
an output process for outputting an analysis result from the analysis process in a displayable manner.

11. A proposal support program causing a processor to execute:
an acquisition process for acquiring a specific first word from a co-occurrence network in which each first word of a first word group in a first sentence group including a first field name in at least one information source out of a first information source related to a first field and a second information source related to a second field different from the first field is a node, and a co-occurrence relationship between two first words is a link connecting the nodes;
an extraction process for extracting company names in the second field related to the specific first word, from a second sentence group including a second field name and the specific first word acquired in the acquisition process, from the at least one information source;
an analysis process for, based on occurrence information regarding a specific second word that co-occurs with the specific first word in a second word group in the second sentence group, associating the specific first word, the specific second word, and the company names in the second field extracted by the extraction process; and
an output process for outputting an analysis result from the analysis process in a displayable manner.
